(19) United States
(12) Patent Application Publication
(10) Pub. No.: US 2018/0148983 A1
(43) Pub. Date: May 31, 2018

(54) Apparatus and Method for Fastening of a Cable to a Tubular Body

(71) Applicant: Innovar Engineering AS, Sola (NO)

(72) Inventor: Karluf Hagen, Stavanger (NO)

(73) Assignee: Innovar Engineering AS, Sola (NO)

(21) Appl. No.: 15/575,907

(22) PCT Filed: May 25, 2016
(86) PCT No.: PCT/NO2016/050103

§ 371 Date: Nov. 21, 2017

(30) Foreign Application Priority Data
May 28, 2015 (NO) 20150678

(51) Int. Cl. E21B 17/02; E21B 17/04; F16L 3/06

(52) U.S. Cl. CPC E21B 17/026; F16L 3/06; E21B 17/04

(57) ABSTRACT

An apparatus and a method are for fastening a cable to a tubular body. The tubular body has a sleeve which is provided with internal bevels at its end portions. The apparatus includes a clamp which is arranged to rest against the sleeve and which has at least one through cable recess. The clamp is formed, at each of its end portions, with a first hook and a second hook, respectively. The hooks complementarily fit the bevels of the sleeve, and the clamp is provided with tensioning means for the hooks.

### FIELD

This invention relates to an apparatus for fastening a cable to a tubular body. More particularly, it relates to an apparatus for fastening a cable to a tubular body, the tubular body comprising a sleeve which is provided with internal bevels at its end portions, and the apparatus comprising a clamp which is arranged to rest against the sleeve and which has at least one through cable recess. The invention also includes a method for fastening a cable to a tubular body.

### BACKGROUND

Parallel to a pipe string that extends down into a well, one or more cables may extend parallel to and on the outside of the pipe string. It will typically be cables for the transmission of power and communication between the surface and components in the well. For such cables not to hang loosely, the cables must be fastened to the pipe string. Today, the fastening is usually done by means of a hinge/clamp which is clamped around the pipe string and secured by means of one or more bolts. The fastening is usually done at the transition between two pipes in the string, such as at a threaded sleeve between two production pipes, for example. U.S. Pat. No. 5,379,836 shows an example of such a clamp.

The annulus outside the pipe string, more often than not bounded by casing, has a limited radial extent, and it has therefore turned out to be difficult to provide fastening devices of sufficient strength.

It is especially when the pipe string is being lowered in the well that great forces may be acting on the attachment. It has turned out on several occasions that fastening devices of today do not have sufficient strength to stand the strains to which they may be subjected. This has turned out to be a particularly great challenge on floating rigs in wintertime.

It is also a problem that bolts that are firmly screwed to bind the hinge together loosen over time because of vibrations in the well. Fastening devices of today are therefore prone to loosen, which leads to halts in production and lost working time as loose parts must be fished out of the well. It goes without saying that such production halts may be very costly.

### SUMMARY

It is therefore an object of the present invention to provide a robust fastening device for attaching cables to tubular bodies.

The invention has for its object to remedy or reduce at least one of the drawbacks of the prior art or at least provide a useful alternative to the prior art.

The object is achieved through the features that are specified in the description below and in the claims that follow.

By making use of the internal bevels of a sleeve to attach a clamp to the tubular body, a new way of attaching a clamp is provided. The method of attachment makes it possible to produce a solid and at the same time slender clamp. The clamp according to the invention is particularly well suited for production wells in which the annulus has a relatively limited radial extent.

The invention is defined by the independent claim(s). The dependent claims define advantageous embodiments of the invention.

In a first aspect, the invention relates more specifically to an apparatus for fastening a cable to a tubular body, the tubular body comprising a sleeve which is provided with internal bevels at its end portions, and the apparatus comprising a clamp which is arranged to rest against the sleeve and has at least one through cable recess, and the apparatus being characterized by the clamp being formed, at each of its end portions, with a first hook and a second hook, respectively, the hooks complementarily fitting the bevels of the sleeve, and the clamp being provided with tensioning means for the hooks.

The kind of sleeve in question here is formed with internal bevels at its end portions. The bevel may appear naturally in the sleeve by the sleeve being formed with internal conical threads, or the bevel may be prefabricated with a view to this type of attachment. The bevel may be arranged to constitute an entry aid when a threaded pipe is being stabbed into the sleeve.

The first and second hooks are adapted to the bevels so that, in the tightened state, the hooks have been moved into their respective bevels, gripping the respective end portions of the sleeve. In this position, the clamp is prevented from being displaceable relative to the sleeve in both radial and axial directions.

In one embodiment, the tensioning means comprise at least one threaded bolt. Alternatively, other known tensioning methods may be used. An example is hydraulic tensioning together with locking dogs, for example.

In one embodiment, an access opening to the threaded bolt may have a smaller diameter than the largest diameter of the threaded bolt. It is thereby ensured that the threaded bolt, if it should come loose, cannot fall out of the clamp.

In one embodiment, the clamp may comprise a first clamp part, which has the first hook, and a second clamp part, which has the second hook. By moving the clamp parts towards each other, the hooks are moved into their respective bevels, after which they are tensioned against the sleeve.

In one embodiment, the first clamp part may be provided with a guiding bulb which fits in a displaceable manner into a guiding recess in the second clamp part. The feature of a guiding-bulb and guiding recess prevents the clamp parts from being movable relative to each other around the sleeve. Radial strain on the threaded bolts is thereby avoided, which might involve a risk of the threaded bolts loosening.

In one embodiment, to hold the cable in position relative to the tubular body in the axial direction as well, the cable recess has a height smaller than the thickness of the cable.

In a second aspect, the invention relates more specifically to a method for fastening a cable to a tubular body, the tubular body comprising a sleeve which is provided with internal bevels at its end portions, and a clamp being arranged to rest against the sleeve and having at least one through cable recess, and the method being characterized by comprising:
clamping a clamp which, at its end portions, is formed with a first hook and a second hook, respectively, against the sleeve, as the cable is placed in the cable recess; and
by means of tensioning means, pulling the hooks into their respective bevels in the sleeve.

Owing to a desired clamping of the cable between the sleeve and the clamp, it may be necessary to use a clamping device to hold the clamp firmly against the sleeve when the hooks are to be moved into their respective bevels.

In one embodiment, during the pulling, the method may include displacing a guiding bulb, which is located in a first clamp part, in a guiding recess, which is located in a second clamp part.

The apparatus and the method according to the invention thus provide a pipe clamp and a fastening method which are able to absorb the prevailing forces, axial ones as well as radial ones. The invention provides for a design without external fastening means and thereby less risk of components from the clamp falling into the well.

### BRIEF DESCRIPTION OF THE DRAWINGS

In what follows, an example of a preferred embodiment and method is described, which is visualized in the accompanying drawings, in which:

FIG. 1 shows a detail, in perspective, of a tubular body with a clamp according to the invention;

FIG. 2 shows an end view of the tubular body and the clamp of FIG. 1;

FIG. 3 shows a section II-II of FIG. 2;

FIG. 4 shows a detail of FIG. 3 on a larger scale; and

FIG. 5 shows the clamp during fitting to the tubular body.

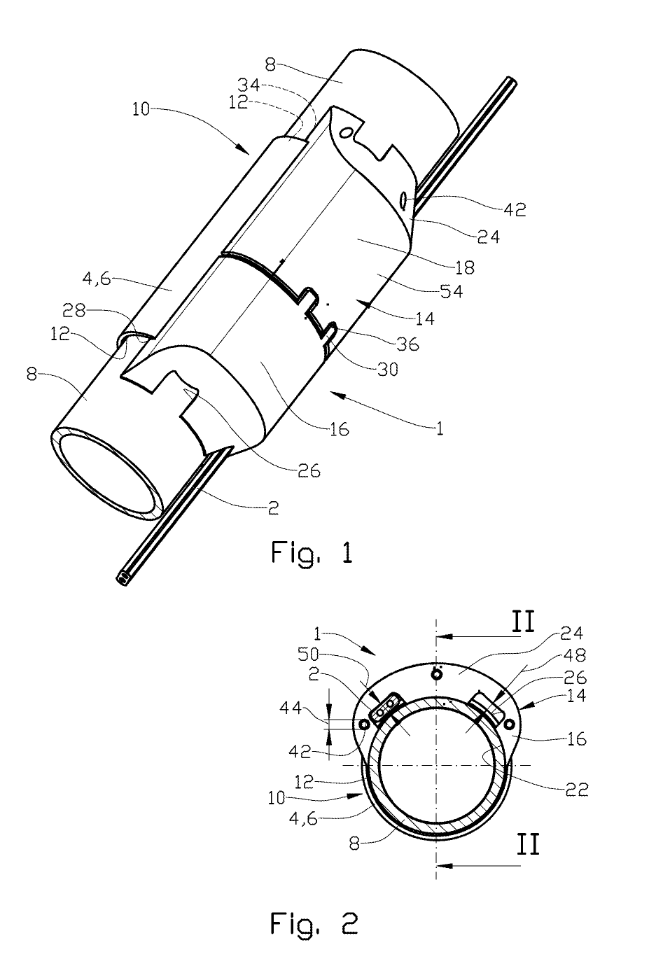

### DETAILED DESCRIPTION OF THE DRAWINGS

In the drawings, the reference numeral 1 indicates an apparatus for fastening a cable 2 to a tubular body 4, here in the form of a sleeve 6 which, together with pipe lengths 8, forms a pipe string 10.

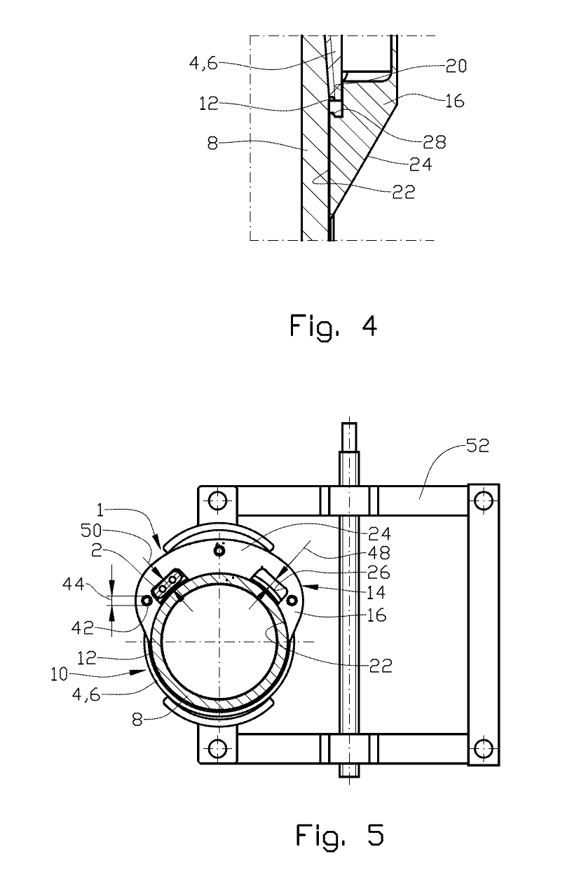

The sleeve 6 is formed with an internal bevel 12 at both its end portions. The bevel 12 is shown best in FIG. 4.

The apparatus 1 comprises a clamp 14 including a first clamp part 16 and a second clamp part 18. Together, the clamp parts 16, 18 span the length of the sleeve 6. Both clamp parts 16, 18 have internal sleeve-abutment surfaces 20 which may rest against the sleeve 6, and pipe-abutment surfaces 22 which may rest against the pipe lengths 8. At their respective, outward-projecting end portions, the clamp parts 16, 18 have conical sloping surfaces 24. Two cable recesses 26 extend through the clamp parts 16, 18.

The first clamp part 16 is provided with a first hook 28 fitting the bevel 12. The first hook 28 extends along the periphery 28 of the pipe length 8, preferably over the entire width of the first clamp part 16.

On its side facing the second clamp part 18, the first clamp part 16 is formed with a pair of guiding bulbs 30. Inside the first clamp part 16, a number of threaded bores 32 directed axially are arranged.

Correspondingly, the second clamp part 18 is provided with a second hook 34 which fits into its bevel 12. On its side facing the first clamp part 16, the second clamp part is formed with a pair of guiding recesses 36 which cooperate with the guiding bulbs 30. The guiding bulbs 30 are axially displaceable in the guiding recesses 36, but prevent sideways displacement between the clamp parts 16, 18.

Internally in the second clamp part 18, bolt bores 38 are arranged, which are concentric with respective threaded bores 32. A threaded bolt 40 is arranged in each bolt bore 38 and threaded bore 32. The threaded bolt 40 may be tightened by means of a key, not shown, which is inserted via an access opening 42. The diameter 44 of the access opening 42 is smaller than the largest external diameter 46 of the threaded bolt 40 to prevent the threaded bolt from falling out of the clamp 14. In this exemplary embodiment, the threaded bore 32, the bolt bore 38 and the threaded bolt 40 constitute tensioning means 41.

Before fitting, the first clamp part 16 and the second clamp part 18 are connected to each other by means of the threaded bolts 40.

When the cable 2, which may comprise at least power or control cables of any kind, has been placed on the sleeve 6, the clamp 14 is applied to the sleeve 6 as the cable 2 is being placed in the cable recess 26.

To tighten the cable 2 between the clamp 14 and the sleeve 6, the height 48 of the cable recess 26 from the sleeve 6 when the clamp 14 has been fitted is smaller than the thickness 50 of the cable 2. It may therefore be necessary to use a clamp 52, see FIG. 5, to press the clamp 14 against the sleeve 6 until the sleeve-abutment surfaces 20 come into abutment against the sleeve 6.

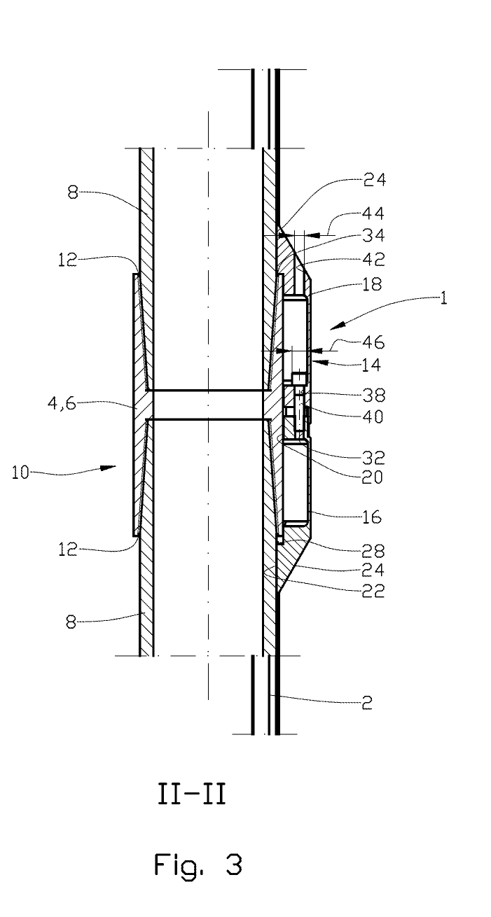

In FIG. 3, the second hook 34 is shown displaced into its bevel 12, whereas the first hook 28 is outside its bevel 12. By inserting the tool, not shown, into the access opening 42 and tightening the threaded bolt 40, the first hook 28 is moved into the bevel 12 while, at the same time, the guiding bulbs 30 are displaced inwards in the guiding recesses 36. Further tightening of the threaded bolt 40 tensions the first hook 28 and the second hook 34 in their respective bevels 12. The mutual lateral locking by means of the guiding bulbs 30, between the clamp parts 16, 18, prevents the threaded bolts 40 from loosening unintendedly.

Axial forces applied to the clamp 14 will press the respective hook 28, 34 further into its bevel 12. Radial forces acting on the clamp 14 will press the clamp 14 further against the sleeve 6. The design of the clamp 14 with sloping surfaces 24 and a relatively smooth external surface 54 also contributes to enabling the clamp 14 to be lowered safely into a well not shown.

It should be noted that all the above-mentioned embodiments illustrate the invention, but do not limit it, and persons skilled in the art will be able to construct many alternative embodiments without departing from the scope of the attached claims. In the claims, reference numbers in parentheses are not to be regarded as restrictive. The use of the verb “to comprise” and its different forms does not exclude the presence of elements or steps that are not mentioned in the claims. The indefinite article “a” or “an” before an element does not exclude the presence of several such elements.

The fact that some features are indicated in mutually different dependent claims does not indicate that a combination of these features cannot be used with advantage.

1. An apparatus for fastening a cable to a tubular body, the tubular body comprising a sleeve which is provided with internal bevels at its end portions, and the apparatus comprising: a clamp which is arranged to rest against the sleeve and which has at least one through cable recess, at each of its end portions, the clamp is formed with a first hook and a second hook, respectively, the hooks complementarily fitting the bevels of the sleeve, wherein the clamp comprises a first clamp part with the first hook and a second clamp part with the second hook, and the clamp being provided with tensioning means for the hooks.

2. The apparatus according to claim 1, wherein the tensioning means comprise at least one threaded bolt.

3. The apparatus according to claim 2, wherein an access opening to the threaded bolt has a smaller diameter than the largest diameter of the threaded bolt.

4. (canceled)

5. The apparatus according to claim 1, wherein the first clamp part is provided with a guiding bulb which fits in a displaceable manner in a guiding recess in the second clamp part.

6. The apparatus according to claim 1, wherein the height of the cable recess is smaller than the thickness of the cable.

7. A method of fastening a cable to a tubular body, the tubular body comprising a sleeve which is provided with internal bevels at its end portions, and a clamp being arranged to rest against the sleeve and having at least one through cable recess, the method comprising:
clamping a clamp, wherein the clamp comprises a first clamp part with a first hook and a second clamp part with a second hook, against the sleeve, the cable being placed in the cable recess; and
with tensioning means, pulling the hooks into their respective bevels in the sleeve.

8. The method according to claim 6, wherein, during the pulling, the method includes displacing a guiding bulb, which is in a first clamp part, in a guiding recess, which is in a second clamp part.
